(19) United States
(12) Patent Application Publication
(10) Pub. No.: US 2021/0169047 A1
(43) Pub. Date: Jun. 10, 2021

(54) For paws sock horn

(71) Applicant: Thomas Prichard Ray Christian, Kirbyville, MO (US)

(72) Inventor: Thomas Prichard Ray Christian, Kirbyville, MO (US)

(21) Appl. No.: 16/602,775

(22) Filed: Dec. 9, 2019

(51) Int. Cl. A01K 13/00

(52) U.S. Cl. CPC A01K 13/007; A47G 25/90

(57) ABSTRACT

A paw sock horn device with a tapered bottom, two tapered sidewalls, and a handle, made of a flexible material such as plastic or steel, wherein the two tapered sidewalls can be folded inward allowing for easy ingress into the elastic cuff of a paw sock that when released force open and hold open, the cuff allowing for easy ingress of the dog's paw into the paw sock. Then simply pull gently on the handle to remove the paw sock horn leaving the sock in place on the dog's paw.

### PRIORITY CLAIM

None

### TECHNICAL FIELD

This invention relates in general to canine footwear, specifically to a paw sock horn, a device used to aid in putting a paw sock on a dog's paw.

### BACKGROUND OF THE INVENTION

Owners of canines, of both indoor pets and working breeds, sometimes have to use paw socks to protect their animal's paws from extreme cold, extreme heat, or even to give them traction on a slippery flooring surface at home or work. Putting these paw socks on can be a stressful event for hyper, skittish, or nervous dogs due to the nature of the elastic cuff meant to hold the paw sock on the animal's paw.

Common paw socks are designed with tight elastic cuffs meant to keep the sock in place while worn. This tight elastic cuff while solving one problem, consequently, creates a new problem; they are difficult to put on. This level of difficulty can lead to owners not putting the paw socks on which can lead to serious injury to the dog: burned paw pads on hot black top or concrete, frostbite in severe cold conditions with snow and ice, or sprained joints and broken bones on slippery floors or other surfaces.

Having only two hands it is impossible for one to hold the dog's paw and spread the elastic cuff of the paw sock wide enough to fit the dog's paw inside without one or more of the dog's toe nails snagging the fabric. If one does get the paw inside the sock the dog's toe nails tend to snag the inside of the cuff also, forcing one to “work” the sock up and over each toe nail.

If one is trying to put these protective paw socks on their dog before going outside to relieve themselves, say after spending the day in a kennel while one is at work, the dogs can already be worked up and excited making the task of putting the sock on even more difficult. Now imagine trying to do that with multiple dogs, all jumping around, anxious to get outside and relieve themselves, the task becomes exponentially more difficult.

With the move away from carpeted floors in pet households, and the move toward various slick, solid surface flooring such as laminate, vinyl plank and tile, in correlation with the dog rescue/foster movement, particularly with senior dogs and special needs dogs, the use of paw socks as injury prevention is on a steep increase. Having the ability to quickly and easily slip the paw sock on becomes vital in creating a stress-free environment for animals who tend to come from extremely stressful pasts.

Consequently, there is a real need for a horn specifically designed to be used with paw socks.

It is the intent of this invention to finally resolve these common problems.

### SUMMARY OF THE DISCLOSURE

A paw sock horn device with a tapered bottom section, two tapered sidewalls and a handle, made of a flexible material such as plastic, wherein the two sidewalls can be folded inward allowing for easy ingress of the elastic cuff of a paw sock that when released, forces open the cuff allowing for easy ingress of the paw into the paw sock. Then, simply pull gently on the handle to remove the paw sock horn leaving the paw sock in place on the paw, or if you will, leaving the paw snugly in place in the paw sock.

### BRIEF DESCRIPTION OF THE DISCLOSURE

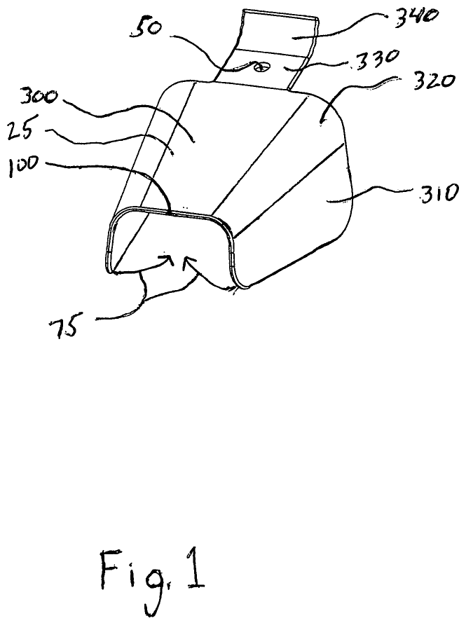

FIG. 1 is a slightly rotated bottom-and-right-side-oriented outer view of a paw sock horn in the “open” or “resting” position, comprised of a tapered bottom section, two tapered sidewall sections, two bottom-to-sidewall radii, a handle with a hole for hanging on a peg and a ¼ radius section at the end for easy removal from the paw sock cuff.

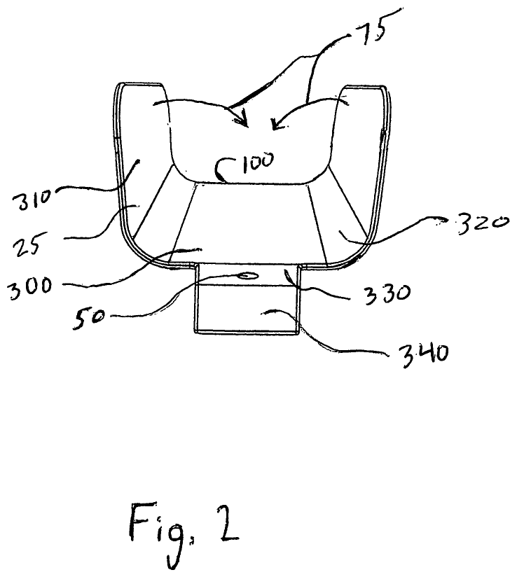

FIG. 2 is a slightly tilted back-to-front-oriented inner view of the paw sock horn depicted in FIG. 1, in the “open” or “resting” position.

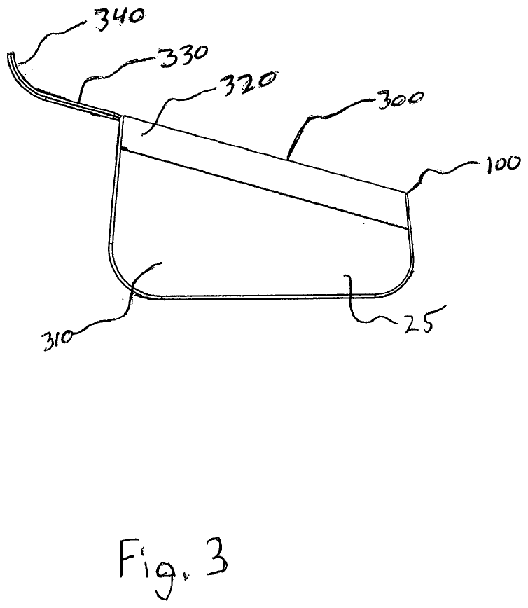

FIG. 3 is a horizontal left-side-oriented outer view of the paw sock horn depicted in FIG. 1, in the “open” or “resting” position,

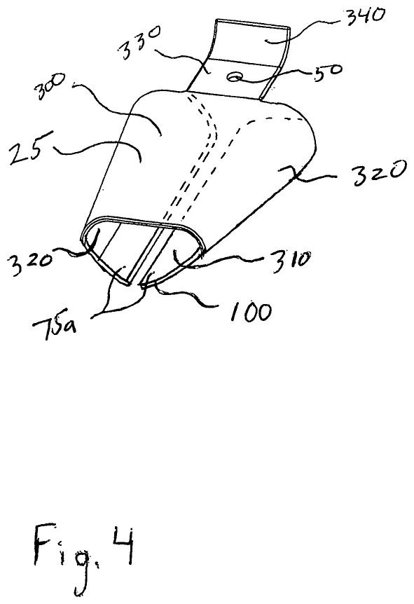

FIG. 4 is of the same view-point of FIG. 1—a slightly rotated bottom-and-right-side-oriented outer view of the paw sock horn depicted in FIG. 1, in the “closed” or “active” position,

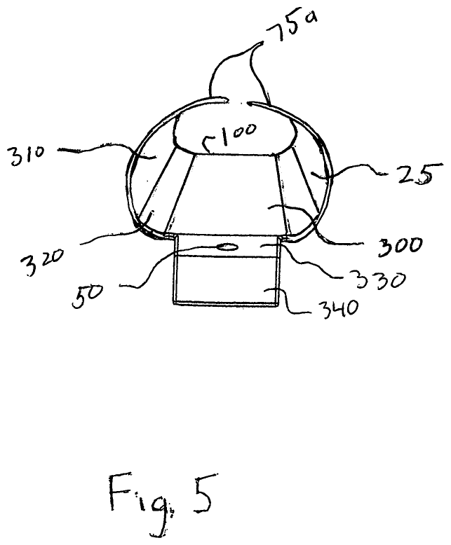

FIG. 5 is of the same view-point of FIG. 2—a slightly tilted back-to-front-oriented inner view of the paw sock horn depicted in FIG. 1, in the “closed” or “active” position,

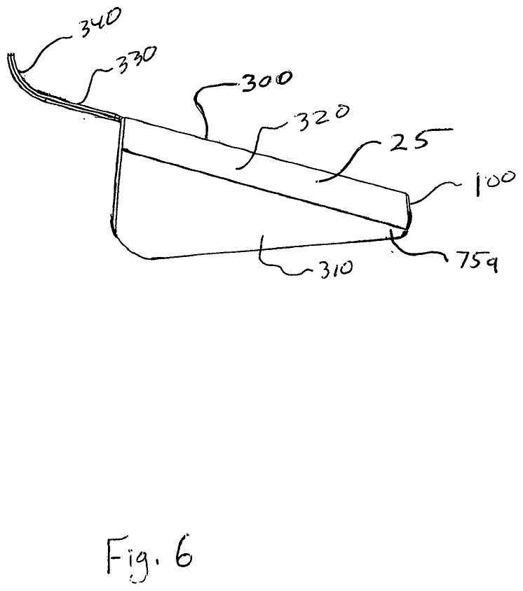

FIG. 6 is of the same view-point of FIG. 3—a horizontal left-side-oriented outer view of the paw sock horn in FIG. 1, in the “closed” or “active” position,

### LEGEND

25—For paws sock horn
50—Hole for hanging on peg
75—Arrows depicting direction of folding of sidewalls
75a—Folded sidewalls in a “closed” or “active” position
100—Leading edge
300—Tapered Bottom
310—Tapered Sidewall
320—Bottom-to-sidewall corner radius
330—Flat portion of handle
340—¼ radius on handle

### DETAILED DESCRIPTION OF THE DISCLOSURE

Reference will now be made in detail to embodiments of this disclosure, examples of which are illustrated in the accompanying drawings. Wherever possible, the same reference numbers will be used throughout the drawings to refer to the same or like parts.

This disclosure describes in detail a paw sock horn comprising a tapered bottom section, two tapered sidewall sections, two bottom-to-sidewall radii and, a handle with a hole for hanging on a peg and a ¼ radius section at the end for easy removal from the paw sock cuff. A paw sock horn that when the flexible tapered sidewalls are folded inward or “closed,” can be easily inserted into the elastic cuff opening of a paw sock and then the sidewalls released; the open sidewalls will hold open the elastic cuff allowing the paw to be easily inserted into the sock. Once the paw is completely inside the paw sock simply pull on the ¼ radius end of the handle to easily remove the paw sock horn from the paw sock cuff leaving the paw neatly inside the paw sock.

FIG. 1, a paw sock horn 25 according to the first embodiment of the present disclosure in the “open” or “resting” position is illustrated. A slightly rotated bottom-and-right-side-oriented outer view of a paw sock horn 25 of the first embodiment that includes a tapered bottom surface 300, two bottom-to-sidewall radii 320, two tapered sidewalls 310 that fold inward 75 to a “closed,” or “active” position allowing for the leading edge 100 to be inserted into the elastic cuff of a paw sock, a handle 330 with a hole 50 for hanging on a peg and a ¼ radius 340 end for gripping.

FIG. 2, a paw sock horn 25 of FIG. 1 in the “open” or “resting” position. A slightly tilted back-to-front-oriented inner view of a paw sock 25 of the first embodiment that includes a tapered bottom surface 300, two bottom-to-sidewall radii 320, two tapered sidewalls 310 that fold inward 75 to a “closed,” or “active” position allowing for the leading edge 100 to be inserted into the elastic cuff of a paw sock, a handle 330 with a hole 50 for hanging on a peg and a ¼ radius 340 end for gripping.

FIG. 3, a paw sock horn 25 of FIG. 1 in the “open” or “resting” position. A horizontal left-side-oriented outer view of a paw sock 25 of the first embodiment that includes a bottom surface 300, two bottom-to-sidewall radii 320, two tapered sidewalls 310 that fold inward 75 allowing for the leading edge 100 to be inserted into the elastic cuff of a paw sock, a handle 330 and a ¼ radius 340 end for gripping.

FIG. 4, a paw sock horn 25 of FIG. 1 in the “closed” or “active” position, from the same view-point of FIG. 1, a slightly rotated bottom-and-right-side-oriented outer view of a paw sock horn 25 of the first embodiment that includes a tapered bottom surface 300, two bottom-to-sidewall radii 320, two tapered sidewalls 310 folded inward to a “closed,” or “active” position 75a allowing for the leading edge 100 to be inserted into the elastic cuff of a paw sock, a handle 330 with a hole 50 for hanging on a peg and a ¼ radius 340 end for gripping.

FIG. 5, a paw sock horn 25 of FIG. 1 in the “closed” or “active” position, from the same view-point of FIG. 2—a slightly tilted back-to-front-oriented inner view of a paw sock 25 of the first embodiment that includes a tapered bottom surface 300, two bottom-to-sidewall radii 320, two tapered sidewalls 310 folded inward to a “closed,” or “active” position 75a allowing for the leading edge 100 to be inserted into the elastic cuff of a paw sock, a handle 330 with a hole 50 for hanging on a peg and a ¼ radius 340 end for gripping

FIG. 6, a paw sock horn 25 of FIG. 1 in the “closed” or “active” position, from the same view-point of FIG. 3—a horizontal left-side-oriented outer view of a paw sock 25 of the first embodiment that includes a tapered bottom surface 300, two bottom-to-sidewall radii 320, two tapered sidewalls 310 folded inward to a “closed,” or “active” position 75a allowing for the leading edge 100 to be inserted into the elastic cuff of a paw sock, a handle 330 and a % radius 340 end for gripping

### INDUSTRIAL APPLICABILITY OF THE DISCLOSURE

In practice, a paw sock horn that may be manufactured, bought or sold, or otherwise obtained according to any of the embodiments described herein.

The components described herein, may be made using a plastic injection molding process. The components may be molded of any suitable thermoplastic material that is easily molded that can provide the end properties needed for any particular application.

The components described herein, may be made using a steel stamping process. The components may be stamped of any suitable steel, aluminum, or metal alloy that can provide the end properties needed for any particular application.

It will be apparent to those skilled in the art that various modifications and variations can be made to the embodiments of the apparatus and methods of assembly as discussed herein without departing from the scope or spirit of the invention. Other embodiments of this disclosure will be apparent to those skilled in the art from consideration of the specification and practice of the various embodiments disclosed herein. For example, some of the equipment may be constructed and function differently than what has been described herein and certain steps may be omitted, performed in an order that is different than what has been specifically mentioned or in some cases performed simultaneously or in sub-steps. Furthermore, variations or modifications, to certain aspects or features (such as but not limited to—length, width, height, angle of tapered sidewalls, angle of tapered bottom) of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

That which is claimed:

1. A paw sock horn with a tapered bottom, two tapered sidewalls, and a handle, manufactured of suitable flexible material, that when the sidewalls are folded inward, can be inserted into the elastic cuff of a paw sock, and when released, open and hold open, said cuff allowing for easy ingress of a dog's paw, and when the paw sock is removed from the paw sock, the paw is left snugly in place in the paw sock.

2. The paw sock horn of claim 1 wherein a ¼ radius is formed at the end of the handle.

3. The paw sock horn of claim 1 wherein a hole for hanging on a peg is located in the handle.
